(19) United States
(12) Patent Application Publication
(10) Pub. No.: US 2012/0074132 A1
(43) Pub. Date: Mar. 29, 2012

(54) INDUCTION HEATING DEVICE AND METHOD FOR CONTROLLING THE SAME

(75) Inventors: Shia-Chung Chen, Taoyuan County (TW); Jen-An Chang, Taoyuan County (TW); Yu-Zeng Lin, Taoyuan County (TW)

(73) Assignee: CHUNG YUAN CHRISTIAN UNIVERSITY, Taoyuan County (TW)

(21) Appl. No.: 13/189,668

(22) Filed: Jul. 25, 2011

(30) Foreign Application Priority Data
Sep. 27, 2010 (TW) 099132653

(51) Int. Cl. H05B 6/08

(52) U.S. Cl. 219/634; 219/600

(57) ABSTRACT

An induction heating device and a method for controlling the same are disclosed, in which the induction heating device is composed of an induction coil and a magnetic conductive plate. The induction coil, being arranged for enabling the same to move relative to a target object, is used for heating the target object after being excited. The magnetic conductive plate is disposed at a specific position proximate to the induction coil that can be varied. According to the positioning of the magnetic conductive plate, the magnetic conductive plate can be used as a shield for blocking the magnetic field resulting from the excited induction coil when it is being positioned between the induction coil and the target object, and the magnetic conductive plate can be used for enhancing the magnetic field when it is being positioned at a side of the induction coil that is away from the target object.

### FIELD OF THE INVENTION

The present invention relates to an induction heating technique for heating a mold, and more particularly, to an induction heating device and the control method thereof capable of using a magnetic conductive plate to control the distribution as well as the strength of the magnetic field induced thereby.

### BACKGROUND OF THE INVENTION

In any dynamic mold temperature control application, the key affecting factors generally are the speed and uniformity of heating. With respect to the speed of heating, there are already many conventional induction heating structures and applications that not only can achieve a satisfactory speed of heating, but also is capable of doing so while achieving significant energy efficiency with a power conversion rate that is higher than 90%.

For instance, one of which is a mold having separate heating and cooling device disclosed in U.S. Pat. No. 6,402,501, in which the mold is designed to be an assembly of two sub-molds according to its separately disposed heating system and cooling system, by that the sub-molds, being comparatively small in size, can be rapidly preheated by the heating system during the mold clamping stroke in mold assembling. Moreover, by embedding the high frequency induction heating coil of the heating system inside grooves formed on the surface of its corresponding sub-mold, not only the time required for the preheating can be shortened, but also the heating efficiency is improved.

Another such device is a device for advancing even distribution of high cycle wave magnetism, that is disclosed in U.S. Pat. No. 6,919,545. The device for advancing even distribution of high cycle wave magnetism uses a coil body having characteristics of conducting high cycle wave magnetism energy. The coil body is coiled in such a way that appears to have undulating distributed layers structure. A plurality of neighboring coil parts is annularly formed to become the coil body. Magnetism goes through any two neighboring coil parts will not repel or counteract each other because the neighboring coil parts are not on the same plane. Thus the present invention can advance high cycle wave magnetic field distributed more evenly.

In addition, further another such device is a device for instantly preheating dies, which is disclosed in U.S. Pat. NO. 6,960,746. The device for instantly pre-heating dies includes an inductive heating coil disposed between two dies. The inductive heating coil includes a spiral shape for generating high frequency induction heat energy. When the dies are separated by a mechanical arm, the inductive heating coil is disposed between die surfaces of the dies, so that high frequency induction heat can act on a die contact part, to allow the die contact part to be pre-heated instantly. As result, not only its pre-heating efficiency is enhanced and the electric energy can also be saved, but also the melted plastic material may be ensured to smoothly flow inside the die contact parts.

As disclosed in the aforesaid patents, a device using induction coils as its heating system is able to heat a mold rapidly or even instantly. However, the issue of uniform heating, which is another important factor relating to the performance of using an induction coil for heating a mold, is still remained to be overcome.

Induction heating is a means of raising the temperature of conductive parts by the transfer of electrical energy from a high-frequency induction coil, which sets up a field of magnetic flux for energizing a target workpiece in such a way that current is caused to flow around its surface. However, since the surfaces of most target workpieces, such as a mold, are not flat, the magnetic filed induced by the coil will concentrated at the surface variations of the workpiece including corners and sharp edges, where they are easily overheated. In addition, since the induction coil is generally being disposed spirally surrounding a target workpiece, the greatest part of the heat generated is on the surface of the workpiece that is diminishing rapidly toward the center thereof, so that uniform heating is difficult.

Therefore, it is in need of a heating means capable of rapid heating while ensuring heating uniformity.

### SUMMARY OF THE INVENTION

In view of the disadvantages of prior art, the primary object of the present invention is to provide an induction heating device and the method for controlling the same, in that a magnetic conductive plate is provided to work in conjunction with an induction coil in a manner that a magnetic field applied upon a target object is deteriorated or enhance with respect to the positioning of the magnetic conductive plate relative to the induction coil so as to control the distribution of the magnetic field accordingly, and thus improve the heating efficiency and the heating uniformity as well.

To achieve the above object, the present invention provides an induction heating device, which is composed of an induction coil and a magnetic conductive plate in a manner that the induction coil is arranged for enabling the same to move relative to a target object so as to be used for heating the target object after being excited; and the magnetic conductive plate is disposed proximate to the induction coil for blocking the magnetic field resulting from the excited induction coil, or for enhancing the magnetic field according to the variation of its positioning.

Moreover, the present invention provides a method for controlling induction heating device, which comprises the steps of:
disposing at least one induction coil at a position proximate to a target object that is to be heated;
disposing at least one magnetic conductive plate at a specific position proximate to the induction coil;
exciting the at least one induction coil; and
varying the position of the at least one magnetic conductive plate for enhancing or blocking the magnetic field induced from the excited induction coil so as to adjust the distribution of the magnetic field.

By disposing the magnetic conductive plate at a side of the induction coil that is neighboring to the target object, the lines of magnetic field induced from the induction coil that are proximate to the magnetic conductive plate are attracted thereby, causing a portion of those magnetic lines to be blocked from being transmitted to the target object; and by disposing the magnetic conductive plate at a side of the induction coil that is away from the target object, the magnetic field relating to an area of the target object that is corresponding to the magnetic conductive plate is enhanced as soon as the magnetic conductive plate is magnetized by the lines of magnetic field induced from the induction coil.

In a preferred embodiment of the invention, the target object is an insert received inside a mold.

In a preferred embodiment of the invention, the magnetic conductive plate is made of a magnetic powder core.

In a preferred embodiment of the invention, the magnetic conductive plate is made of a soft magnetic material.

In a preferred embodiment of the invention, the thickness of the magnetic conductive plate is about 3 mm

In a preferred embodiment of the invention, the thickness of the magnetic conductive plate is preferably to be larger than 5 mm

In a preferred embodiment of the invention, the target object is configured with at least one corner, which is an area of the target object where distance measured from the induction coil to the area is varying; and when the magnetic conductive plate is positioned between the induction coil and the target object, the magnetic conductive plate is located at a position corresponding to the corner so as to be used as a shield for blocking the magnetic field and thus weakening the magnetic filed applied on the corner.

In a preferred embodiment of the invention, when the induction coil is being disposed spirally surrounding the target object and the magnetic conductive plate is disposed at the side of the induction coil that is away from the target object, the magnetic conductive plate is located at a position corresponding to the middle of the induction coil so as to enhance the magnetic filed relating to the middle of the induction coil.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a schematic diagram showing an induction heating device according to an embodiment of the invention.

FIG. 2 is a flow chart depicting steps performed in a control method for induction heating device according to the present invention.

FIG. 3 is a schematic diagram showing a magnetic conductive plate that is positioned at a side of an induction coil proximate to a target object so as to be used as a shield for blocking the magnetic field and thus weakening the magnetic filed applied on the area of the target object corresponding to the position of the magnetic conductive plate.

FIG. 4 is a schematic diagram showing a magnetic conductive plate that is positioned at a side of an induction coil away from a target object so as to enhance the magnetic field applied on the area of the target object that is corresponding to the position of the magnetic conductive plate.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

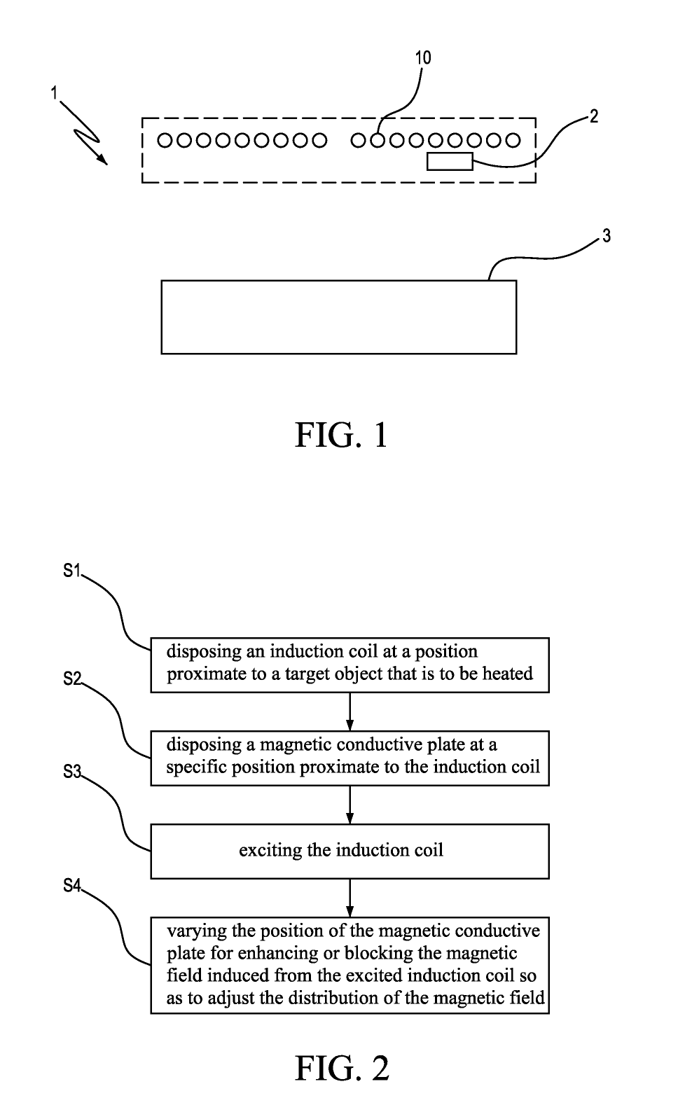

Please refer to FIG. 1 to FIG. 4, which are a schematic diagram showing an induction heating device according to an embodiment of the invention; a flow chart depicting steps performed in a control method for induction heating device according to the present invention; a schematic diagram showing a magnetic conductive plate that is positioned at a side of an induction coil proximate to a target object so as to be used as a shield for blocking the magnetic field and thus weakening the magnetic filed applied on the area of the target object corresponding to the position of the magnetic conductive plate; and a schematic diagram showing a magnetic conductive plate that is positioned at a side of an induction coil away from a target object so as to enhance the magnetic field applied on the area of the target object that is corresponding to the position of the magnetic conductive plate.

As shown in FIG. 1, a induction heating device 1 of the invention is composed of an induction coil 10 and a magnetic conductive plate 2 in a manner that the induction coil 10 is arranged for enabling the same to move relative to a target object 3, such as an insert received inside a mold, so as to be used for heating the target object 3 after being excited; and the magnetic conductive plate 2 is disposed proximate to the induction coil 10 for blocking or enhancing the magnetic field resulting from the excited induction coil 10 according to the variation of its positioning.

As shown in FIG. 2, a control method for induction heating device comprises the steps of:
S1: disposing an induction coil 10 at a position proximate to a target object 3 that is to be heated;
S2: disposing a magnetic conductive plate 2 at a specific position proximate to the induction coil 10;
S3: exciting the induction coil 10; and
S4: varying the position of the magnetic conductive plate 3 for enhancing or blocking the magnetic field induced from the excited induction coil 10 so as to adjust the distribution of the magnetic field and thus enabling the target object 3 to be heated uniformly.

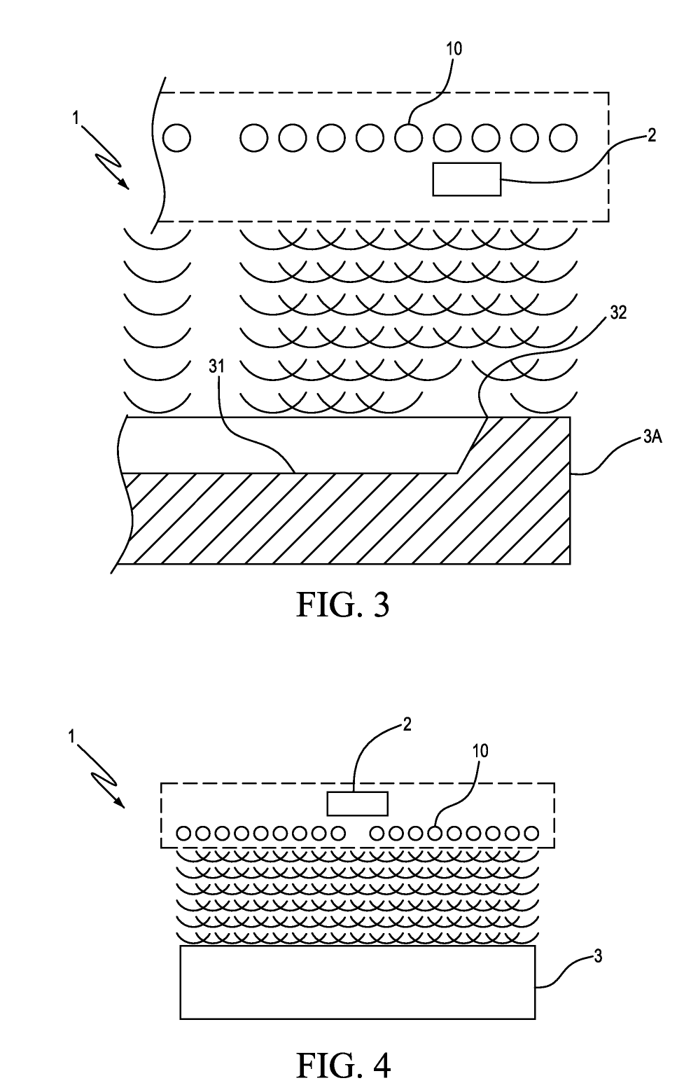

In this embodiment, the induction heating device is composed of only one induction coil and only one magnetic conductive plate, but it is only for illustration and thus will not be limited thereby. Generally, there can be one induction coil working in conjunction with a plurality of magnetic conductive plates, or can be a plurality of induction coils working in conjunction with a plurality of magnetic conductive plates. Moreover, the target object 3 can be an insert 3A that is received inside a mold, as the one shown in FIG. 3. In addition, the magnetic conductive plate 2 can be made of a magnetic powder core or a soft magnetic material, into a shape selected from the group consisting of: blocks, sheets and the like; whereas the thickness of the magnetic conductive plate 2 can be manufactured larger than 3 mm, but is preferably to be larger than 5 mm

By varying the position of the magnetic conductive plate 3 for adjusting the distribution of the magnetic field induced by the induction coil 10, the heating of the target object 3 can be controlled accordingly.

As shown in FIG. 3, when the target object 3 is an insert 3A having a cavity 31 formed therein, there is a corner 32 being formed which is an area of the insert 3A where distance measured from the induction coil 10 to the insert 3A is varying, resulting from the depth variation of the cavity 31. Consequently, for preventing the corner 32 from being affected by end effect during induction heating, the magnetic conductive plate 3 will be located at a side of the induction coil 10 proximate to the target object 3 at a position corresponding to the corner 32. Thereby, the lines of magnetic field induced from the induction coil 10 that are proximate to the magnetic conductive plate 3 will be attracted thereby for causing a portion of those magnetic lines to be blocked from being transmitted to the target object 3. Consequently, comparing with other magnetic lines, only a small portion of those magnetic lines neighboring to the magnetic conductive plate 3 can be transmitted to the target object 3 relating to the area corresponding to the magnetic conductive plate 3, so that the heating to the area of the target object 3 that is corresponding to the magnetic conductive plate 3 is weakened.

As shown in FIG. 4, when the induction coil 10 is being disposed spirally surrounding the target object 3, the magnetic field inducted by the induction coil is generally at its weakest at the middle thereof that is going to adversely affect the heating uniformity of the target object 3. Therefore, the magnetic conductive plate 2 is disposed at a side of the induction coil away from the target object 3 at a position corresponding to the middle of the induction coil 10, by that the lines of magnetic field induced from the induction coil 10 that are proximate to the magnetic conductive plate 3 will be attracted thereby for magnetizing the same and thus causing the magnetic field relating to an area of the target object 3 that is corresponding to the magnetic conductive plate 3 to be enhanced as the magnetic conductive plate is located at the far side of the induction coil 10 with respect to the target object 3.

To sum up, by disposing the magnetic conductive plate at a side of the induction coil that is neighboring to the target object, a portion of those magnetic lines will be shielded and blocked from being transmitted to the target object; on the other hand, by disposing the magnetic conductive plate at a side of the induction coil that is away from the target object, the magnetic field relating to an area of the target object that is corresponding to the magnetic conductive plate is enhanced. Therefore, by varying the position of the magnetic conductive plate with reference to the heating requirement of the target object, the distribution of the magnetic field induced by the induction coil can be controlled for achieving a satisfactory heating efficiency and good heating uniformity for the target object.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. An induction heating device, comprising:
an induction coil, being arranged for enabling the same to move relative to a target object so as to be used for heating the target object after being excited; and
at least one magnetic conductive plate, each being disposed at a specific position proximate to the induction coil for blocking or enhancing the magnetic field resulting from the excited induction coil according to the variation of its positioning.

2. The induction heating device of claim 1, wherein target object is an insert received inside a mold.

3. The induction heating device of claim 1, wherein the magnetic conductive plate is made of a magnetic powder core into a shape selected from the group consisting of: blocks, sheets and the like.

4. The induction heating device of claim 1, wherein the magnetic conductive plate is made of a soft magnetic material into a shape selected from the group consisting of: blocks, sheets and the like.

5. The induction heating device of claim 1, wherein the specific position where the at least one magnetic conductive plate is located is a position on a side of the induction coil proximate to the target object.

6. The induction heating device of claim 1, wherein the specific position where the at least one magnetic conductive plate is located is a position on a side of the induction coil away from the target object.

7. The induction heating device of claim 1, wherein the thickness of the magnetic conductive plate is larger than 3 mm

8. The induction heating device of claim 1, wherein the thickness of the magnetic conductive plate is larger than 5 mm

9. The induction heating device of claim 1, wherein the target object is configured with at least one corner, which is an area of the target object where distance measured from the induction coil to the area is varying; and the magnetic conductive plate is located at a position corresponding to the at least one corner.

10. The induction heating device of claim 1, wherein the induction coil is being disposed spirally surrounding the target object and the magnetic conductive plate is disposed at a position corresponding to the center of the induction coil.

11. A control method for induction heating device, comprising the steps of:
disposing at least one induction coil at a position proximate to a target object that is to be heated;
disposing at least one magnetic conductive plate at a specific position proximate to the at least one induction coil;
exciting the at least one induction coil; and
varying the position of the magnetic conductive plate for enhancing or blocking the magnetic field induced from the excited induction coil so as to adjust the distribution of the magnetic field.

12. The control method of claim 11, wherein the specific position where the at least one magnetic conductive plate is located is a position on a side of the induction coil proximate to the target object for enabling the at least one magnetic conductive plate to act as a shield for blocking the magnetic field induced from the at least one induction coil.

13. The control method of claim 12, wherein the target object is configured with at least one corner, which is an area of the target object where distance measured from the induction coil to the area is varying; and the magnetic conductive plate is located at a position corresponding to the at least one corner.

14. The control method of claim 11, wherein the specific position where the at least one magnetic conductive plate is located is a position on a side of the induction coil away from the target object for enhancing the magnetic field induced from the at least one induction coil.
